(19) United States
(12) Patent Application Publication
(10) Pub. No.: US 2026/0238949 A1
(43) Pub. Date: Aug. 13, 2026

(54) SYSTEM AND METHOD FOR GENERATING SPATIAL AUDIO FOR MULTI-USER VIDEO CONFERENCE CALL USING MULTI-FOLD USER DEVICE

(71) Applicant: SAMSUNG ELECTRONICS CO., LTD., Suwon-si (KR)

(72) Inventors: Gurmanjeet Singh SIDHU, Noida (IN); Sergey LOSSEV, Noida (IN)

(73) Assignee: SAMSUNG ELECTRONICS CO., LTD., Suwon-si (KR)

(21) Appl. No.: 19/633,284

(22) Filed: Mar. 30, 2026

Related U.S. Application Data
(63) Continuation of application No. PCT/KR2024/008968, filed on Jun. 27, 2024.

(30) Foreign Application Priority Data
Oct. 5, 2023 (IN) 202311066814

(51) Int. Cl. H04S 7/00; G06T 3/40; G06T 7/70; H04R 5/027

(52) U.S. Cl. CPC H04S 7/303; G06T 3/40; G06T 7/70; H04R 5/027; G06T 2200/24; G06T 2207/10016; G06T 2207/30196; G06T 2207/30244; H04S 2400/11; H04S 2400/15

(57) ABSTRACT

A method, performed by an electronic device, of generating spatial audio for a multi-user video call. The method including determining an angular position of at least one camera. The at least one camera is disposed on each of a plurality of display portions. The method including determining an orientation of a user with respect to the at least one camera based on the determined angular position. The method including obtaining a first virtual microphone by selecting at least two microphones from among a plurality of microphones based on the determined orientation of the user and the determined angular position of the at least one camera. The method including obtaining, by using the first virtual microphone, at least one audio feed in a field of view (FOV) of the at least one camera. The method including generating the spatial audio based on the obtained at least one audio feed.

### CROSS-REFERENCE TO RELATED APPLICATIONS

This application is a Bypass Continuation application of International Application PCT/KR2024/008968 filed on Jun. 27, 2024, which claims benefit of Indian Patent Application number 202311066814, filed on Oct. 5, 2023 at the Indian Intellectual Property Office, the disclosures of which are incorporated herein in their entireties by reference.

### BACKGROUND

### Field

Embodiments of the present disclosure are generally directed to the field of video conferencing and spatial audio, and more particularly relate to a method and system for generating spatial audio for multi-user video conference call (hereinafter used interchangeably with ‘video call’) using a multi-fold user device.

### Description of Related Art

In the era of digital communication and remote collaboration, video calling has become an indispensable tool for connecting individuals and teams across geographical boundaries. This technology enables real-time visual and auditory interaction, promoting seamless communication even when participants are physically distant. One common scenario in video calling involves two individuals who are physically in the same location but wish to participate in a multi-user video conference, often with remote participants. While this may seem straightforward, it presents unique challenges and limitations that impact the overall user experience. Some of the challenges and limitations are discussed below.

Consider a situation where multiple users are present in the same physical location (e.g., a common area where multiple users are present in the vicinity of each other) and want to engage in a video call. Each user can use their individual devices to join the video call. Alternatively, the user can share a single device and attempt to physically squeeze together to fit within the single device camera's frame. However, such an arrangement of attending a multi-user video call can be uncomfortable and restrict the natural movements and expressions of the individual user, potentially hindering effective communication.

Further, using a single device often results in mono audio output, where multiple speakers' voices seem to come from the same direction. The mono audio output can make it challenging for participants to discern who is speaking, especially when multiple users are present at the same physical location. Thus, in the multi-user video call, identifying speakers becomes a significant challenge.

Moreover, some devices, such as foldable phones, have limitations in activating both front cover and main display cameras simultaneously due to hardware configurations. This restricts the flexibility of using multiple camera angles during the video call. Users may opt for speaker mode to avoid holding the phone to their ear during the video call. However, this choice can create feedback loops and unwanted audio interference when the users are in the same room, compromising the user experience.

Accordingly, there lies a need to provide a solution to the above-described limitations.

Information disclosed in this Background section has already been known to or derived by the inventors before or during the process of achieving the embodiments of the present application, or is technical information acquired in the process of achieving the embodiments. Therefore, it may contain information that does not form the prior art that is already known to the public.

### SUMMARY

This summary is provided to introduce a selection of concepts, in a simplified format, that are further described in the detailed description of the invention. This summary is neither intended to identify essential inventive concepts of the invention nor is it intended for determining the scope of the invention.

According to an embodiment of the disclosure, disclosed herein is a method, performed by an electronic device, of generating spatial audio for a multi-user video call. The method may include determining an angular position of at least one camera. The at least one camera is disposed on each of a plurality of display portions. The method may include determining an orientation of a user with respect to the at least one camera based on the determined angular position. The method may include obtaining a first virtual microphone by selecting at least two microphones from among a plurality of microphones based on the determined orientation of the user and the determined angular position of the at least one camera. The method may include obtaining, by using the first virtual microphone, at least one audio feed in a field of view (FOV) of the at least one camera. The method may include generating the spatial audio based on the obtained at least one audio feed.

In an embodiment, the generating the spatial audio includes obtaining a first audio feed associated with the FOV of the at least one camera, and one or more second audio feeds associated with FOV of remaining cameras corresponding to remaining display portions of the plurality of display portions; and generating the spatial audio to be shared in an outbound stream by combining the first audio feed and the one or more second audio feeds.

In an embodiment, the first audio feed is obtained by using the first virtual microphone, and the one or more second audio feeds are obtained by using one or more second virtual microphones associated with the remaining cameras.

In an embodiment, the method includes obtaining a plurality of frames associated with at least one video feed from the at least one camera of corresponding display portions of the plurality of display portions; processing the obtained plurality of frames by adjusting a size of the plurality of frames based on one or more view parameters associated with the outbound stream; merging the adjusted plurality of frames to be shared in the outbound stream. The outbound stream includes the combined at least one video feed and the spatial audio. The method includes transmitting the outbound steam to a remote user's device.

In an embodiment, the processing of the obtained plurality of frames is performed based on a predefined frame per second (FPS) rate.

In an embodiment, the method includes generating an interface associated with a corresponding view. The corresponding view includes the at least one video feed associated with the remote user and the obtained plurality of frames associated with the FOV of the at least one camera of the corresponding display portions. The method includes rendering the interface on the corresponding display portion.

In an embodiment, the one or more view parameters is a set of settings that define how the outbound stream is displayed on the remote user's device.

According to an embodiment of the disclosure, disclosed herein is an electronic device for generating spatial audio for a multi-user video call. The electronic device may include a plurality of display portions, at least one camera, a plurality of microphones, a memory storing one or more instructions, and at least one processor coupled to the memory. The at least one processor is configured to execute the one or more instructions to cause the electronic device to determine an angular position of the at least one camera. The at least one camera is disposed on each of the plurality of display portions. The at least one processor is configured to execute the one or more instructions to cause the electronic device to determine an orientation of a user with respect to the at least one camera based on the determined angular position. The at least one processor is configured to execute the one or more instructions to cause the electronic device to obtain a first virtual microphone by selecting at least two microphones from among the plurality of microphones based on the determined orientation of the user and the determined angular position of the at least one camera. The at least one processor is configured to execute the one or more instructions to cause the electronic device to obtain, by using the first virtual microphone, at least one audio feed in a field of view (FOV) of the at least one camera. The at least one processor is configured to execute the one or more instructions to cause the electronic device to generate the spatial audio based on the obtained at least one audio feed.

In an embodiment, to generate the spatial audio, the at least one processor is further configured to execute the one or more instructions to cause the electronic device to: obtain a first audio feed associated with the FOV of the at least one camera, and one or more second audio feeds associated with FOV of remaining cameras of remaining display portions of the plurality of display portions; and generate the spatial audio to be shared in an outbound stream by combining the first audio feed and the one or more second audio feeds.

In an embodiment, the first audio feed is obtained by using the first virtual microphone, and the one or more second audio feeds are obtained by using one or more second virtual microphones associated with the remaining cameras.

In an embodiment, the at least one processor is further configured to execute the one or more instructions to cause the electronic device to: obtain a plurality of frames associated at least one video feed from at least one camera of corresponding display portions of the plurality of display portions; process the obtained plurality of frames by adjusting a size of the plurality of frames based on one or more view parameters associated with the outbound stream; merge the adjusted plurality of frames to be shared in the outbound stream. The outbound stream includes the combined the at last one video feed and the spatial audio. The at least one processor is further configured to execute the one or more instructions to cause the electronic device to: transmit the outbound steam to a remote user's device.

In an embodiment, processing the obtained plurality of frames is performed based on a predefined frame per second (FPS) rate.

In an embodiment, the at least one processor is further configured to execute the one or more instructions to: generate an interface associated with a corresponding view. The corresponding view includes the at least one video feed associated with the remote user and the obtained plurality of frames associated with the FOV of the at least one camera of the corresponding display portions. The at least one processor is further configured to execute the one or more instructions to: render the interface on the corresponding display portion.

In an embodiment, the one or more view parameters is a set of settings that define how the outbound stream is displayed on the remote user's device.

According to an embodiment of the present disclosure, disclosed is computer-readable storage medium storing instructions, wherein the instructions, when executed by at least one processor, cause the electronic device to perform the method.

To further clarify the advantages and features of the present disclosure, a more particular description of the disclosure will be rendered by reference to specific embodiments thereof, which are illustrated in the appended drawings. It is appreciated that these drawings depict only typical embodiments of the disclosure and are therefore not to be considered limiting of its scope. The disclosure will be described and explained with additional specificity and detail in the accompanying drawings.

### BRIEF DESCRIPTION OF DRAWINGS

The above and other aspects, features, and advantages of certain example embodiments of the present disclosure will be more apparent from the following description taken in conjunction with the accompanying drawings, in which:

FIG. 1 is a schematic diagram of an exemplary environment illustrating a plurality of users engaged in a video call with a remote user using a multi-fold device, according to an embodiment of the present disclosure;

FIG. 2 is a block diagram depicting an exemplary multi-user video and spatial audio generation system, according to an embodiment of the present disclosure;

FIG. 3 is a block diagram depicting modules of the multiuser video and spatial audio generation system, according to an embodiment of the present disclosure;

FIG. 4 is a schematic diagram depicting the steps of an exemplary virtual mic generation module, according to an embodiment of the present disclosure;

FIGS. 5A-5D are schematic diagrams depicting the creation of virtual mics by the virtual mic generation module, according to an embodiment of the present disclosure;

FIG. 6 is a schematic diagram depicting an exemplary frame optimizer module, according to an embodiment of the present disclosure;

FIG. 7 is a schematic diagram depicting an exemplary frame rendering sub-module, according to an embodiment of the present disclosure; and

FIGS. 8A-8B are flow diagrams depicting the method for generating spatial audio of two or more users using a multi-fold user device, according to an embodiment of the present disclosure.

Further, skilled artisans will appreciate that elements in the drawings are illustrated for simplicity and may not have necessarily been drawn to scale. For example, the flow charts illustrate the method in terms of the most prominent steps involved to help to improve understanding of aspects of the present disclosure. Furthermore, in terms of the construction of the device, one or more components of the device may have been represented in the drawings by conventional symbols, and the drawings may show only those specific details that are pertinent to understanding the embodiments of the present disclosure so as not to obscure the drawings with details that will be readily apparent to those of ordinary skill in the art having the benefit of the description herein.

### DETAILED DESCRIPTION

For the purpose of promoting an understanding of the principles of the disclosure, reference will now be made to the various embodiments and specific language will be used to describe the same. It should be understood at the outset that although illustrative implementations of the embodiments of the present disclosure are illustrated below, the present disclosure may be implemented using any number of techniques, whether currently known or in existence. The present disclosure is not necessarily limited to the illustrative implementations, drawings, and techniques illustrated below, including the exemplary design and implementation illustrated and described herein, but may be modified within the scope of the present disclosure

It will be understood by those skilled in the art that the foregoing general description and the following detailed description are explanatory of the disclosure and are not intended to be restrictive thereof.

Reference throughout this specification to “an aspect”, “another aspect” or similar language means that a particular feature, structure, or characteristic described in connection with the embodiment is included in at least one embodiment of the present disclosure. Thus, appearances of the phrase “in an embodiment”, “in another embodiment” and similar language throughout this specification may, but do not necessarily, all refer to the same embodiment.

It is to be understood that as used herein, terms such as, “includes,” “comprises,” “has,” etc. are intended to mean that the one or more features or elements listed are within the element being defined, but the element is not necessarily limited to the listed features and elements, and that additional features and elements may be within the meaning of the element being defined. In contrast, terms such as, “consisting of” are intended to exclude features and elements that have not been listed.

The embodiments herein and the various features and advantageous details thereof are explained more fully with reference to the non-limiting embodiments that are illustrated in the accompanying drawings and detailed in the following description. Descriptions of well-known components and processing techniques are omitted to not unnecessarily obscure the embodiments herein. Also, the various embodiments described herein are not necessarily mutually exclusive, as some embodiments can be combined with one or more other embodiments to form new embodiments. The term “or” as used herein, refers to a non-exclusive or unless otherwise indicated. The examples used herein are intended merely to facilitate an understanding of ways in which the embodiments herein can be practiced and to further enable those skilled in the art to practice the embodiments herein. Accordingly, the examples should not be construed as limiting the scope of the embodiments herein.

As is traditional in the field, embodiments may be described and illustrated in terms of blocks that carry out a described function or functions. These blocks, which may be referred to herein as units or modules or the like, are physically implemented by analog or digital circuits such as logic gates, integrated circuits, microprocessors, microcontrollers, memory circuits, passive electronic components, active electronic components, optical components, hardwired circuits, or the like, and may optionally be driven by firmware and software. The circuits may, for example, be embodied in one or more semiconductor chips, or on substrate supports such as printed circuit boards and the like. The circuits constituting a block may be implemented by dedicated hardware, by a processor (e.g., one or more programmed microprocessors and associated circuitry), or by a combination of dedicated hardware to perform some functions of the block and a processor to perform other functions of the block. Each block of the embodiments may be physically separated into two or more interacting and discrete blocks without departing from the scope of the disclosure. Likewise, the blocks of the embodiments may be physically combined into more complex blocks without departing from the scope of the disclosure.

The accompanying drawings are used to help easily understand various technical features and it should be understood that the embodiments presented herein are not limited by the accompanying drawings. As such, the present disclosure should be construed to extend to any alterations, equivalents, and substitutes in addition to those which are particularly set out in the accompanying drawings. Although the terms first, second, etc. may be used herein to describe various elements, these elements should not be limited by these terms. These terms are generally only used to distinguish one element from another.

As discussed above, there are several constraints when multiple users intend to participate in the same video call using a single foldable device simultaneously. An object of the present disclosure is to provide a system and a method for enabling two or more users to attend a video call using the single foldable device with enhanced user experience. Hereinafter, the term ‘foldable device’ may be used interchangeably with ‘multi-fold device.’

The present disclosure achieves the above-described objectives by providing a multi-user video and spatial audio generation system to generate spatial audio and provide a consistent and synchronized combined video feed of two or more users using a multi-fold user device. In an embodiment, a ‘multi-fold device’ is a type of foldable device featuring one or more flexible display portions, allowing the device to be compressed or extended. Examples of a multi-fold device may include, but are not limited to, foldable smartphones, foldable tablets, and other such devices with at least one flexible display portion. The multi-fold device may also include a minimum of one camera on each of the display portions, enhancing its functionality for diverse applications, such as photography, video conferencing, and multi-screen experiences.

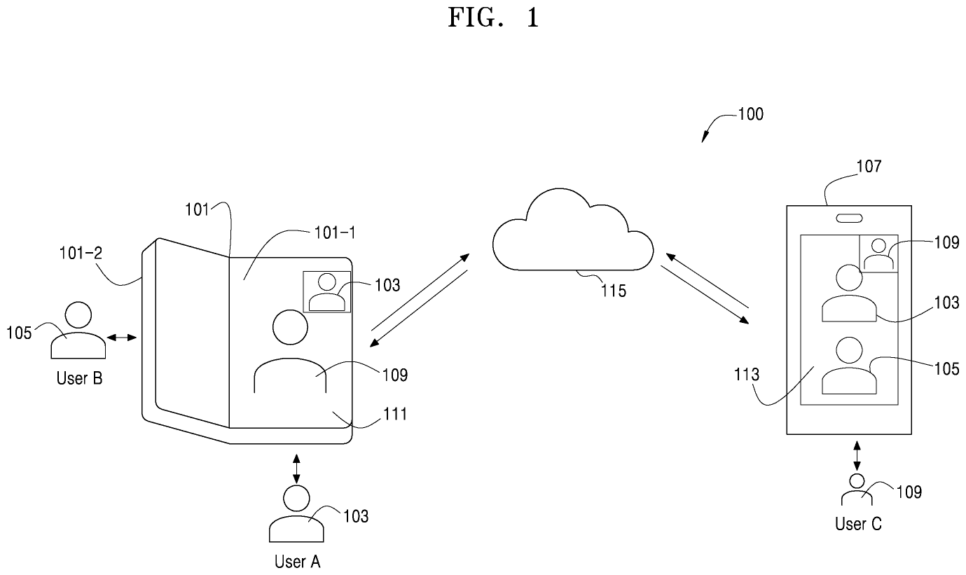

Another objective of the present disclosure is to combine video feeds from the camera of each display to create a consistent and synchronized video feed for the remote users on their mobile devices during the video call. The techniques provided in the present disclosure are now described in detail in conjunction with FIGS. 1-8.

FIG. 1 is a schematic diagram of an exemplary environment 100 illustrating a plurality of users engaged in a video call with a remote user using a multi-fold device, according to an embodiment of the present disclosure. The environment may include a multi-fold device 101 used by a user A 103, and a user B 105 to engage in a video conference with a remote user, i.e., user C 109 using a remote device 107. The multi-fold device 101 may include multiple display portions such as a main display portion 101-1 and a front cover display portion 101-2. The multi-fold device 101 may include two or more cameras, such that each display screen is equipped with at least one camera. While the figure depicts the multi-fold device 101 having two display portions, it may be appreciated that the multi-fold device 101 may include more than two display portions. In an exemplary embodiment, the remote user device 107 may also be a multi-fold device having similar configuration and features as that of the multi-fold device 101.

In the exemplary environment 100 depicted in FIG. 1, user A 103 may be present before the main display portion 101-1, while user B 105 may be present before the front cover display portion 101-2 using the respective camera on the corresponding display portions. In an embodiment, user B 105 may be present before the main display portion 101-1, while user A 103 may be present before the front cover display portion 101-2. In an embodiment, the main display portion 101-1 may display a view 111 including the remote user C 109 and a self-view of the user A 103. Similarly, the front cover display portion 101-2 may display another view including the remote user C 109 and a self-view of the user B 105. According to an embodiment of the present disclosure, video feeds from the respective camera on each display portion may be combined and shared with the remote user device 107 in an outbound stream. The outbound stream when rendered at the remote user device 107, presents a view 113 where the multiple users (i.e., user A 103 and user B 105) are displayed in individual boxes. From the perspective of remote user C 109, it would seem as though multiple users are participating in the video call using separate, individual devices. In other words, the remote user C 109 may not be indicated that the multiple users are utilizing a single device, i.e., multi-fold device 101, to join the video call.

Further, the multi-fold device 101, and the remote user device 107 may communicate using corresponding applications installed on the individual devices via an application server 115. The application may be designed for video conferencing enabling users to conduct real-time video meetings, fostering remote collaboration, and communication through live video and audio interactions. The application server 115 may be associated with the applications and facilitate collaborative services such as video conferencing among multiple devices such as the multi-fold device 101 and the remote user device 107.

Furthermore, the multi-fold device 101 may also include a plurality of microphones configured to capture audio from the users who are nearby. The terms ‘microphone’ and ‘microphones’ may be used interchangeably with the terms ‘mic’ and ‘mics’ respectively. As discussed above, when multiple users use the same device to participate in a video call, an issue related to feedback loops and unwanted audio interference may arise, resulting in a poor user experience.

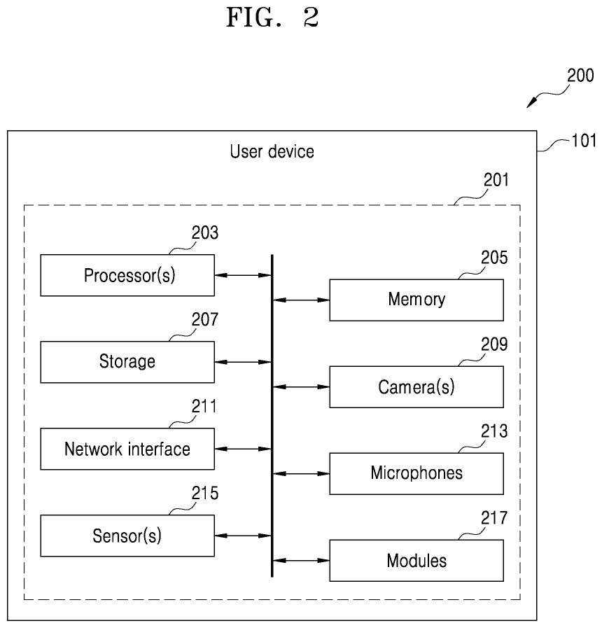

According to an embodiment of the present disclosure, the aforementioned issue is addressed by creating, for a corresponding user present in front of at least one camera disposed on a display portion of the plurality of display portions, a virtual microphone by selecting at least two microphones from the plurality of microphones based on the orientation of the user and angular position of the at least one camera. The virtual microphone may be utilized to capture audio feed in a field of view (FOV) of the at least one camera of the display portion based on the orientation of the corresponding user as if coming from the corresponding user, and generate spatial audio for the remote user attending the video call. Similarly, one or more audio feeds may be captured in the FOV of the corresponding camera of each display portion. Finally, the audio feeds may be combined to generate spatial audio to be shared in the outbound stream. The outbound stream may include the combined video feeds and the spatial audio to be shared with the remote user device 107. The outbound stream is generated using the multi-user video and spatial audio generation system as described below in conjunction with FIG. 2.

FIG. 2 is a block diagram 200 depicting an exemplary multi-user video and spatial audio generation system 201, according to an embodiment of the present disclosure. The multi-user video and spatial audio system 201 may be present in the multi-fold device 101 and may include a processor(s) 203, a memory 205 (e.g., RAM), a storage 207 (e.g., ROM), a camera(s) 209, a network interface 211, a plurality of microphones 213, sensors 215, and modules 217. The processor(s) 203 is configured to execute instructions stored in the system memory 205 and to perform various operations as described in the embodiments of the present disclosure. The processor(s) 203 may include specialized processing units such as integrated system (bus) controllers, memory management control units, floating point units, graphics processing units, digital signal processing units, etc. In one embodiment, the processor(s) 203 may include a central processing unit (CPU), a graphics processing unit (GPU), or both. The processor(s) 203 may be one or more general processors, digital signal processors, application-specific integrated circuits, field-programmable gate arrays, servers, networks, digital circuits, analog circuits, combinations thereof, or other now known or later developed devices for analyzing and processing data. The processor(s) 203 may execute one or more instructions, such as code generated manually (i.e., programmed) to perform one or more operations disclosed herein throughout the disclosure.

The storage 207 may include one or more databases to store one or more data and information that may be to implement the system 201. The camera(s) 209 may include two or more integrated cameras such that at least one camera is disposed on each of the plurality of display portions of the multi-fold device 101. Each camera of the camera(s) 209 may have an individual field of view (FOV), configured to capture video feeds from individual users positioned in front of the corresponding cameras. This arrangement ensures personalized and synchronized video inputs, enhancing the overall video conferencing experience. The network interface 211 provides network connectivity and enables communication with the remote user device 107 over a network. The plurality of microphones 213 may be configured to capture clear and immersive audio from the surroundings of the multi-fold device 101. The plurality of microphones 213 may be strategically placed to enhance the audio reception of the multi-fold device 101, making it ideal for group discussions, video calls, and various communication scenarios.

The sensors 215 may be included to enhance the functionality of the multi-fold device 101. The sensors 215 may include but are not limited to, an inertial measurement unit (IMU) and a hinge sensor. The IMU may refer to a combination of accelerometers and gyroscopes to measure the device's motion and orientation in three-dimensional space. The hinge sensor may refer to a type of sensor used in various devices, such as laptops, foldable smartphones, and other devices with hinge mechanisms. A primary function of the hinge sensors is to detect the position, angle, or movement of the hinge. Based on the detected position, angle, or movement, the hinge sensor may trigger specific actions or adjustments within the multi-fold device. For example, the hinge sensor might detect when the multi-fold device 101 is folded or unfolded and adjust the display or switch between different modes accordingly. According to embodiments of the present disclosure, data obtained from the sensors 215 may be utilized in the creation of virtual microphones to generate spatial during a video call using modules 217.

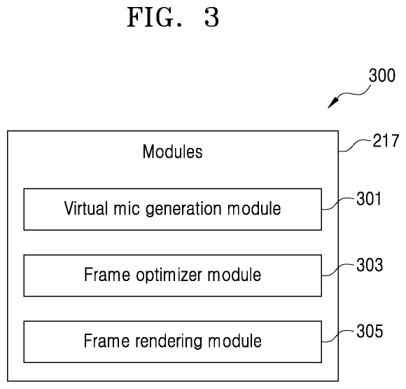

The modules 217 may include a set of instructions that may be executed to cause the multiuser video and spatial audio generation system 201 to capture and combine video feeds and audio feeds of multiple users (e.g., user A and user B) present in front of corresponding cameras of the multi-fold device 101. The modules 217 are described below in detail in conjunction with FIG. 3.

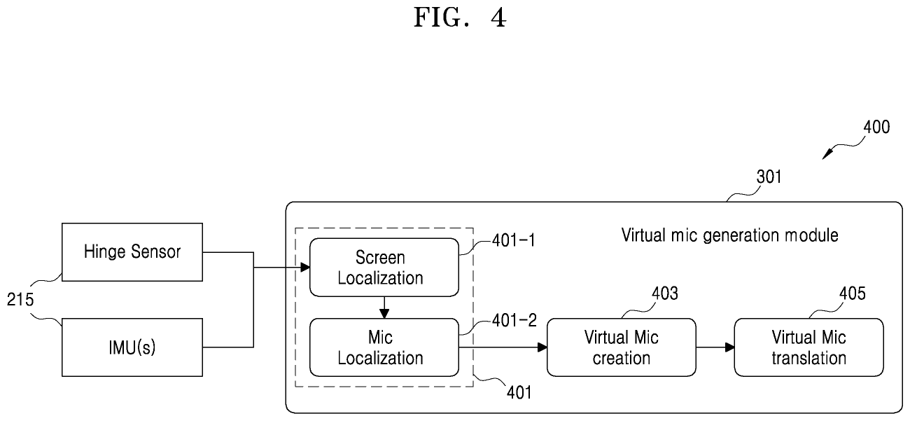

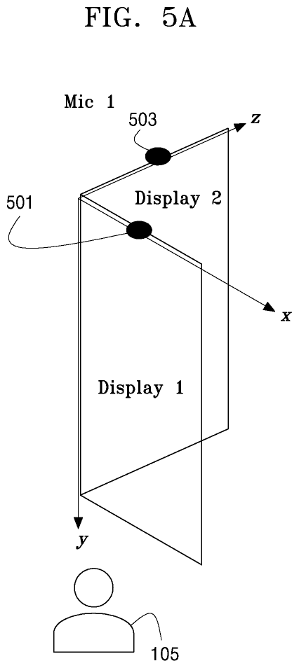

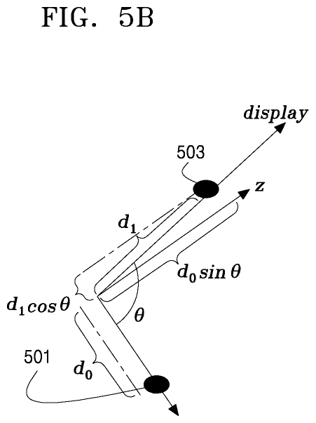

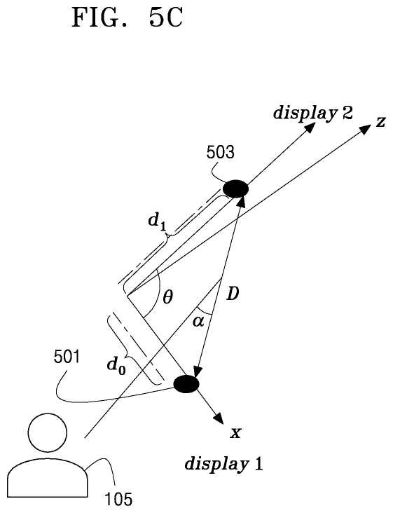

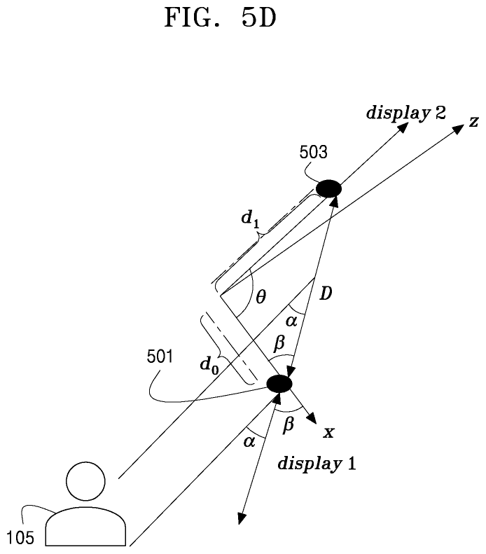

FIG. 3 is a block diagram 300 depicting modules 217 of the multiuser video and spatial audio generation system 201, according to an embodiment of the present disclosure. The modules 217 may include a virtual mic generation module 301, a frame optimizer module 303, and a frame rendering module 305. The virtual mic generation module 301 may be configured to create one or more virtual microphones using multiple physical microphones positioned strategically within the multi-fold device 101. According to an embodiment of the present disclosure, by processing the audio signals from the virtual microphones, the direction of sound sources and the distance therefrom may be estimated accurately. The virtual mic generation module 301 may enable spatial audio capture and immersive sound reproduction, enhancing the overall audio experience in applications such as teleconferencing, and video conferencing systems. The virtual mic generation module 301 is described in greater detail below in conjunction with FIG. 4 and FIGS. 5A-5D.

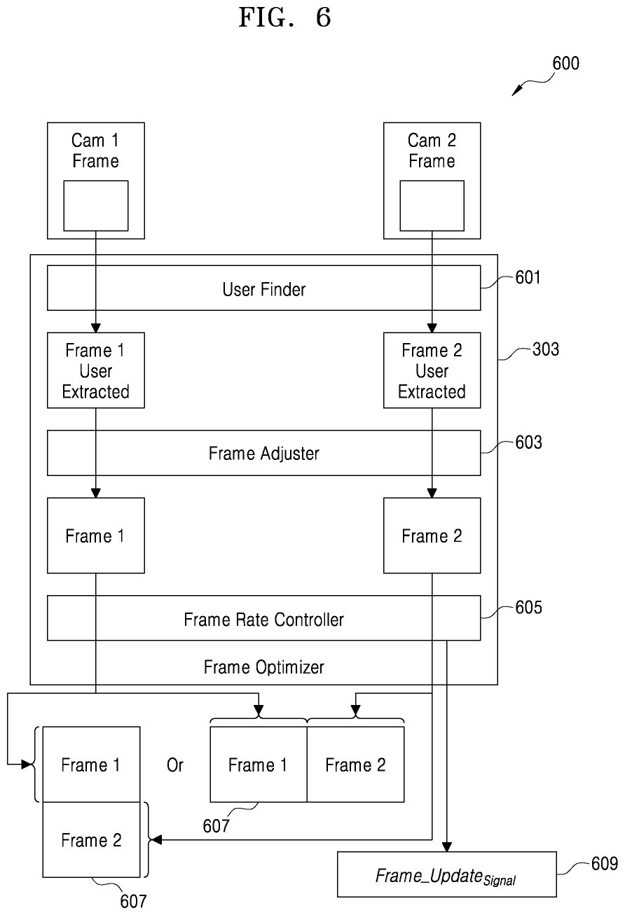

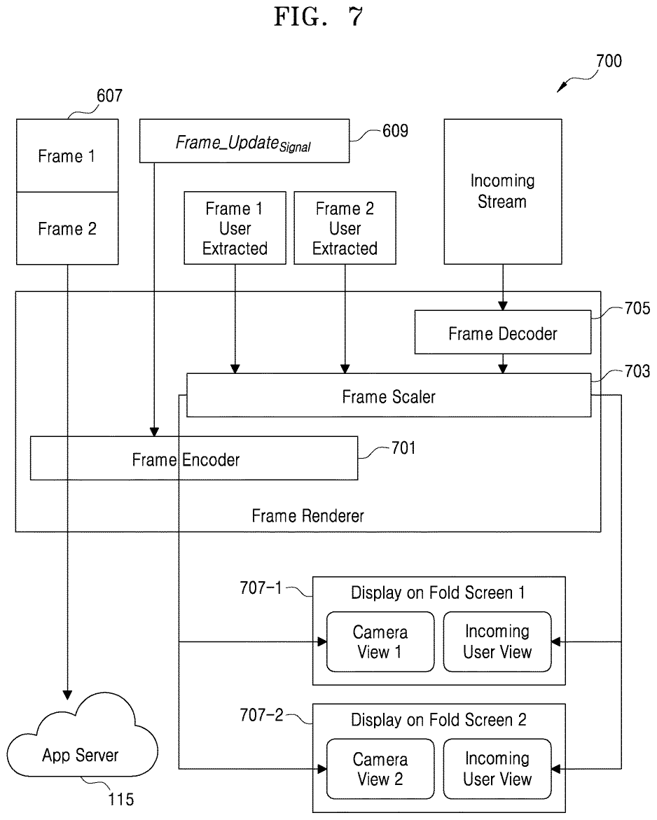

The frame optimizer module 303 may be configured to obtain (e.g. capture, receive, download) frames associated with video feeds of individual users captured from respective cameras positioned on the corresponding display portions of the multi-fold device 101. The frame optimizer module 303, synchronizes and optimizes the obtained frames, and arranges the obtained frames in a final frame to be shared with the remote user device 107. The frame optimizer module 303 optimizes the frame generation rate by using a frame rate controller based on the application requirement and enables seamless communication and collaboration among multiple users (user A, user B, and user C) on the multi-fold device 101. The frame optimizer module 303 is described in greater detail in conjunction with FIG. 6. The frame rendering module 305 may be configured to facilitate the generation of an interface on the multi-fold device 101 and/or the remote device 107. The interface may refer to a corresponding view including video feeds associated with the remote user. The corresponding view may further include frames associated with the cameras of the multi-fold device 101. Further, the frame rendering module 305 may be configured to render the interface on the display portions of the multi-fold device 101. The frame optimizer module 303 is described in greater detail in conjunction with FIG. 7.

FIG. 4 is a schematic diagram 400 depicting the steps of an exemplary virtual mic generation module 301, according to an embodiment of the present disclosure. FIGS. 5A-5D are schematic diagrams depicting the creation of virtual mics by the virtual mic generation module 301, according to an embodiment of the present disclosure. Referring collectively to FIGS. 4 and 5A-5D, the virtual mic generation module 301 may be configured to perform operations for creating a virtual mic, i.e., operations of localization 401, virtual mic creation 403, and virtual mic translation 405 with respect to FOV of the respective camera of the corresponding display portion. In an embodiment, virtual mics may be generated for any type of multi-fold device, for example, the foldable device having more than two or more display portions. However, the present disclosure, for the sake of brevity and ease of understanding, describes the virtual mic generation from the perspective of a multi-fold device having two display portions.

The localization 401 may further include two sub-operations, screen localization 401-1, and mic localization 401-2. In screen localization 401-1, the virtual mic generation module 301 may obtain motion-related data from sensor 215, particularly, hinge sensors and IMU sensors. The data obtained from the sensors 215 may be used to identify and determine the precise location and orientation of the plurality of display portions. The screen localization 401-1 may allow the multi-fold device 101 to understand how the display portions are positioned with respect to each other and adjust the content, user interface, or functionality of the multi-fold device 101 accordingly. As a result, in the screen localization operation 401-1, the virtual mic generation module 301 may determine a hinge angle Θ, between the two display portions marked as ‘display 1’, and ‘display 2’ in FIG. 5A. In the illustrated embodiment of FIGS. 5A-5D, display 1 may correspond to the front cover display portion 101-2 of the multi-fold device 101, and display 2 may correspond to the main display portion 101-1 of the multi-fold device 101. In an exemplary embodiment, the virtual mic generation module 301 in the screen localization 401-1 operation may determine the hinge angle Θ between display 1 and display 2.

Based on the determined hinge angle, the virtual mic generation module 301 in the mic localization operation 401-2 determines the distance of each microphone of the plurality of microphones strategically positioned in the multi-fold device 101 from the hinge of the multi-fold device 101. The distance of each microphone from the hinge may be determined in the plane of the corresponding display portion. In an exemplary embodiment, for user B 105 present in front of display 1, the distance of each microphone such as mic 501, and mic 503 in FIG. 5A, is determined in the plane of display 1. For example, as shown in FIG. 5B, the distance of mic 501 from the hinge may be determined as d₀ in the plane of display 1. Further, the distance of mic 503 from the hinge may be determined as d₁ cos(Θ) Θ in the plane of display 1, where d₁ is the distance of mic 503 from the hinge in the plane of display 2. Similarly, d₁ may represent the distance of mic 503 from the hinge, and d₀ sin(Θ) may represent the distance of mic 501 from the hinge when the distance of the mics 501 and 503 is determined in the plane of display 2.

Thereafter, for each pair of microphones in the plurality of microphones, the pair having a maximum distance there-between in each axis of display 1 perpendicular to a reference (e.g., gravity) is selected. For example, the x-axis may be selected when the multi-fold device is held by a user in portrait mode, and the y-axis may be selected when the multi-fold device is held by a user in landscape mode. Further, the selected pair of microphones may be used to determine the horizontal angle and vertical angle of a user with respect to the plane of the corresponding display portion. In an embodiment, the horizontal angle may correspond to the angle in a horizontal plane, such that the plane passing through the corresponding camera and facing the corresponding user is considered as the horizontal plane. Accordingly, the vertical angle may correspond to the angle in a vertical plane, such that the vertical plane refers to the plane perpendicular to the display to which the corresponding user is facing, i.e., the horizontal plane. In the present example as depicted in FIG. 5C, a pair of mic 501 and 503 may be selected to determine the horizontal angle and vertical angle of user B 105 from display 1.

Further, at the virtual mic creation operation 403, a virtual mic is created by the virtual mic generation module 301 based on the selected pair of mics. In the example depicted in FIGS. 5C, and 5D, a virtual mic with respect to user B 105 in front of display 1 is created based on the selected pair of microphones 501 and 503. Firstly, the distance between the selected pair of mics in the actual physical configuration is determined. For example, when display 1 and display 2 are held at an angle Θ the distance between the mics 501 and 503 may be determined as having a distance ‘D’ in the physical configuration of the multi-fold device 101. Upon determination of the distance between the selected mics, the time taken by sound signals to reach the mics is determined. For example, sound signals, originating from user B 105 side, would take D/34300 seconds to travel ‘D’ distance and reach mic 503, where 34300 cm/s corresponds to the speed of sound in air at standard atmospheric conditions. Thereafter, a time difference of the sound signals received at the selected pair of mics is determined. In an embodiment, for determination of the time difference, a sampling frequency greater than or equal to 48 KHz is selected based on predetermined calibration of plurality of sampling frequencies.

Furthermore, an angle α between the user B 105 and a baseline corresponding to the plane obtained by joining the selected pair of microphones is determined. To determine α, the time difference, denoted as Δt between sound signals s1, received at mic 501, and sound signal s2, received at mic 503 is determined based on a cross-correlation between 10 ms signals. The cross-correlation ‘c’ may be defined as c=xcorr(s1, s2). The delay Δt may be defined as Δt=lag/sampling frequency, where lag=mod(find(c=max(c)), length(s2)). The angle α^{∝} is determined using the equation (1) defined below:

$$α = {cos}^{- 1} = ( \frac{Δ t \cdot x}{D} ) , where x = speed of sound \qquad ( 1 )$$

Finally, a first virtual mic v1 is created based on the selected pair of mics such that the user B 105 is positioned at angle α^{∝} from the plane obtained by joining the selected pair of microphones. At this point, the baseline corresponding to the plane may be considered as the baseline for the first virtual mic v1.

Moreover, the virtual mic is translated with respect to the FOV of the respective camera disposed on the corresponding display portion of the multi-fold device. The translation of the first virtual mic v1 corresponds to an angle γ between a baseline of the display (display 1) and the user (user B 105) as depicted in FIG. 5D. γ is defined as γ=α+β, where β is the angle between the baseline of first virtual microphone v1 and current display, i.e., display 1. β is defined as equation (2) below:

$$β = {cos}^{- 1} ( \frac{{D}^{2} + {d}_{0}^{2} - {d}_{1}^{2}}{2 \cdot D \cdot {d}_{0}} ) \qquad ( 2 )$$

Based on the translation of the virtual mic as described above, spatial audio corresponding to sound signals captured from the direction of user B 105 may be generated. The sound signals captured from the direction of user B 105 may be referred as the first audio feed. In an embodiment, similar steps as described above with reference to virtual mic v1 may be executed to determine a second virtual microphone v2 associated with user A 103. In such case, sound signals captured from the direction of the user A 103 may be referred to as a second audio feed. According to an embodiment of the present disclosure, spatial audio corresponding to the second audio feed may be generated using the second virtual mic v2. Further, final spatial audio may be generated by combining the spatial audio feeds corresponding to the first audio feed and/or the second audio feed. Eventually, the final spatial audio feed is shared with the remote user device 107 in an outbound stream. In an embodiment, an ‘outbound stream’ refers to video and audio data sent by the participants (for example, user A 103 and user B 105) in the video conference to one or more remote participants (for example, user C 109) via the application server 115. The outbound stream includes the final spatial audio feed along with a combined video feed of the participants. The combined video feed may be generated using the frame optimizer module 303 as described below in conjunction with FIG. 6.

FIG. 6 is a schematic diagram 600 depicting an exemplary frame optimizer module 303, according to an embodiment of the present disclosure. The frame optimizer module 303 is configured to capture a plurality of frames associated with at least two video feeds from at least two cameras of corresponding display portions of the plurality of display portions. The frame optimizer module 303 may include a user finder sub-module 601, a frame adjuster sub-module 603, and a frame rate controller sub-module 605. The captured plurality of frames is then processed by adjusting the size of the plurality of frames based on one or more view parameters associated with the outbound stream. In an embodiment, the captured frames are processed at a predefined frame per second (FPS) rate. In an embodiment, one or more view parameters may refer to a set of settings that define how the content (frames) is displayed or presented to the viewer (e.g., user C 109) on the remote user device 107.

The one or more view parameters may include various aspects related to the visual experience, such as, but not limited to frame rate corresponding to the frames per second processed by the remote user device 107 based on corresponding camera capability and network conditions, display size of the remote user device 107, a desired aspect ratio, and cropping and scaling related parameters to specify how frames of the video feeds are cropped or scaled to fit within the display area while maintaining the desired aspect ratio at the remote user device 107. Particularly, camera resolution and frame rate being greater than a predetermined threshold at user device 101 side, can lead to excessive bandwidth consumption. However, the network at the user device 101 may not be sufficiently stable to transmit such data. Hence, the one or more view parameters may be balanced based on network conditions at the remote user device 107. The adjusted plurality of frames corresponding to at least two video feeds is then merged into a final video feed. The final video feed is combined with the final spatial audio feed to generate the outbound stream to be shared with the remote user device 107. The operations for obtaining the final video feed are now explained in greater detail.

In the initial operation, frames associated with video feeds of individual users are captured from two or more cameras. The individual camera frames are then adjusted to a resolution such that the length (Lₜ) is greater than or equal to three-fourths (¾) of the original length (L), and the width (WₜWₜ) is greater than or equal to three-fourths (¾) of the original width (W). and may correspond to the length and width of the frame corresponding to i^{th} camera. Thereafter, YUV planes corresponding to each frame are captured in a predetermined video pixel format. In an embodiment, the YUV color space may correspond to the representation of colors using three components: Y (luma or brightness), U (chrominance or blue-luma), and V (chrominance or red-luma). In an embodiment, the predetermined video pixel format may refer to NV12, which is in a 4:2:0 format, with each pixel value represented by 8 bits, but not limited thereto. Finally, orientation correction is applied to the captured frames, taking into consideration that the width (W) is always greater than the height (H) of the image. Each of the corrected frames is then used as input to the frame optimizer module 303.

Before sending to the frame adjuster sub-module 603, corrected frames from each of the two or more cameras are received at the user finder sub-module 601 of the frame optimizer module 303. In the user finder sub-module 601, the face of each user is extracted from the corresponding frames using a predetermined face finder model. In an embodiment, frames may be used directly from the two or more cameras. The extracted face of each user is adjusted by the frame adjuster sub-module 603. The frame adjuster sub-module 603 is configured to adjust the frames into the output size based on one or more view parameters such as the aspect ratio (H/W) defined as

$$\frac{{h}_{scale \_ output}}{{w}_{scale \_ output}} .$$

To adjust the frames, the frames are scaled to h_{scale_output}, w_{scale_output} and adjusted based on predefined padding values, p_{padding}, to make the final frame 607 to be rendered at the remote user device 107. The height H_{final_height}, and width W_{final_height} of the final frame 607 may be determined by equations (3) and (4):

$${h}_{scale \_ output} + {p}_{padding} = {H}_{final \_ height} \qquad ( 3 )$$

$${v}_{scale \_ output} - {p}_{padding} = {W}_{final \_ height} \qquad ( 4 )$$

In an embodiment, if the scaled_output (h_{scale_output} and w_{scale_output}) is greater than final_output (H_{final_height} and W_{final_height}) then the cropping operation is performed, otherwise padding operation is performed. Finally, the generation of the final frame 607 is controlled, by the frame rate controller sub-module 605 based on one or more view parameters such as frame rate. In an embodiment of the present disclosure, the final frame 607 is associated with the final video feed. In an embodiment, Frame_Update signal 609 is a signal sent at regular intervals and indicate when to copy and encode a buffer onto an outgoing signal.

According to an embodiment of the present disclosure, the frame rendering sub-module 305 is configured to render frames on the display portions of the multi-fold device 101 and is described in detail below in conjunction with FIG. 7.

FIG. 7 is a schematic diagram 700 depicting an exemplary frame rendering sub-module 305, according to an embodiment of the present disclosure. The frame rendering sub-module 305 may be configured to render the frames of an incoming stream from the remote user device 107 along with a self-view of the respective user on the corresponding display portions. In an exemplary embodiment, the incoming stream refers to the video and audio data associated with a remote user (e.g., user C 109) received from a remote user device (e.g., the remote user device 107) during a video conference. The frame rendering sub-module 305 is further configured to generate a corresponding interface associated with a corresponding view, wherein the corresponding view includes at least one video feed associated with the remote user and the captured plurality of frames associated with the FOV of the corresponding at least one camera of the corresponding display portions. Finally, the frame rendering sub-module 305 is configured to render the corresponding interface on the corresponding display portion.

In an embodiment, the cropped or padded frames obtained from the frame optimizer sub-module 303 are encoded using the encoder 701. The encoded frames are then processed and rendered on the corresponding display portion of the multi-fold device 101 based on view parameters associated with the respective camera on the corresponding display portion. At first, encoded frames are scaled to meet the view parameters associated with the respective camera using a frame scaler 703. The scaled frames are then rendered on the corresponding display portion in a suitable format using below equation (5). In an embodiment, the suitable format may be joint photographic experts group (JPEG) format.

$$[ \begin{matrix}R \\ G \\ B\end{matrix} ] = [ \begin{matrix}1.164 & 0 & 1.596 \\ 1.164 & - 0.391 & - 0.813 \\ 1.164 & 2.018 & 0\end{matrix} ] [ \begin{matrix}Y - 16 \\ U \\ V\end{matrix} ] . \qquad ( 5 )$$

In an embodiment of the present disclosure, the frame rendering sub-module 305 is configured to pack the YUV frame planes of the final frame 607 to be included in the output stream and shared with the remote user device 107 via the application server 115. Further, the received incoming stream is also scaled using the frame scaler 703 based on the view parameters of the corresponding display portion, and then converted in the suitable format (e.g., jpeg format) using the above-mentioned equation (5). The frame decoder 705 may refer to a generic frame decoder which decodes the frames of the incoming stream and makes multiple buffers for multiple display portions such that the frame scaler 703 can scale based on each of the display portion resolution. The frames associated with the incoming stream along with the frame associated with the user in front of the respective camera are rendered on the corresponding display portion as depicted in blocks 707-1 corresponding to the display rendered on a first display portion (display 1), and 707-2 corresponding to the display rendered on a second display portion (display 2).

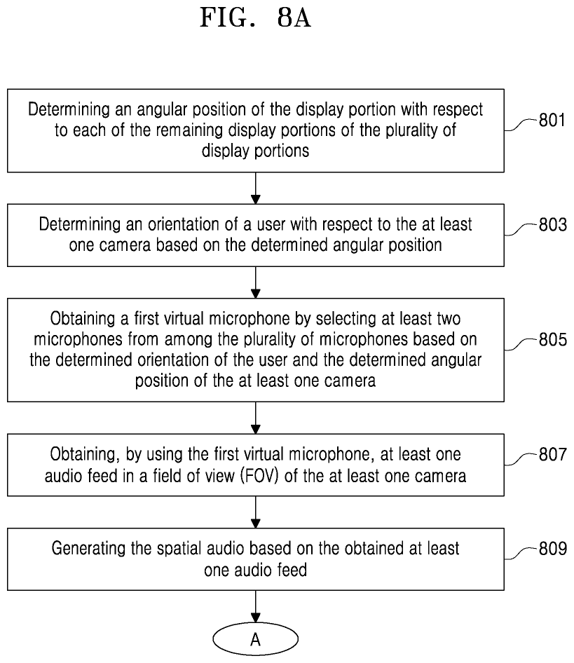

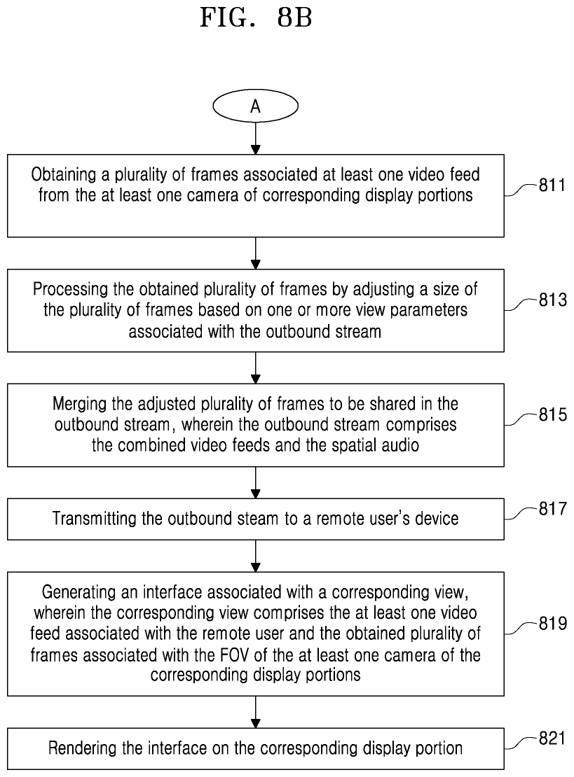

FIGS. 8A-8B are flow diagrams depicting the method 800 for generating spatial audio of two or more users using a multi-user device, according to an embodiment of the present disclosure. The method 800, at operation 801, includes determining an angular position of the at least one camera such that the at least one camera is disposed on each of the plurality of display portions. Thereafter, at operation 803, the method 800 includes determining an orientation of a user with respect to the at least one camera based on the determined angular position. Based on the determined orientation of the user and the determined angular position of the at least one camera, the method 800, at operation 805 includes obtaining a first virtual microphone by selecting at least two microphones from among the plurality of microphones. Thereafter, the method 800, at operation 807, includes obtaining, by using the first virtual microphone at least one audio feed in a field of view (FOV) of the at least one camera (209).

Based on the obtained at least one audio feed, the method 800, at operation 809, includes generating the spatial audio. In an embodiment, generating the spatial audio includes obtaining a first audio feed associated with the FOV of the at least one camera, and one or more second audio feeds associated with FOV of remaining cameras corresponding to the remaining display portions, and then, generating the spatial audio to be shared in an outbound stream by combining the first audio feed and the one or more second audio feeds. In an embodiment, the first audio feed may be obtained by using the first virtual microphone, and the one or more second audio feeds may be obtained by using one or more second virtual microphones associated with the remaining cameras. Thereafter, the method 800, at operation 811, includes obtaining a plurality of frames associated at least one video feed from at least one camera of corresponding display portions. Thereafter, the method 800, at operation 813, includes processing the obtained plurality of frames by adjusting a size of the plurality of frames based on one or more view parameters associated with the outbound stream. In an embodiment, the processing of the obtained plurality of frames is performed based on a predefined frame per second (FPS) rate.

Thereafter, the method 800, at operation 815, includes merging the adjusted plurality of frames to be shared in the outbound stream, wherein the outbound stream includes the combined video feeds and the spatial audio. Thereafter, the method 800, at operation 817, includes transmitting the outbound steam to a remote user's device. Thereafter, the method 800, at operation 819, includes generating interface associated with corresponding view, wherein corresponding view includes at least one video feed associated with remote user and obtained plurality of frames associated with the FOV of the at least one camera of corresponding display portions. Finally, at operation 821, the method 800 includes rendering the interface on the corresponding display portion.

While the above operations of FIGS. 8A-8B are shown and described in a particular sequence, the operations may occur in variations to the sequence in accordance with various embodiments of the disclosure. Further, a detailed description related to the various operations of FIGS. 8A-8B is already covered in the description related to FIGS. 1-7 and is omitted herein for the sake of brevity.

At least by virtue of aforesaid, the present subject matter at least provides the following advantages:

According to one embodiment of the present disclosure, disclosed herein is a method for generating spatial audio for a multi-user video conference call using a multi-fold user device having a plurality of display portions and a plurality of microphones. The method may include determining an angular position of at least one camera, such that the at least one camera is disposed on each of the plurality of display portions. The method may include determining an orientation of a corresponding user with respect to the at least one camera based on the determined angular position. Based on the determined orientation of a corresponding user and the determined angular position of the at least one camera, the method may include creating a first virtual microphone by selecting at least two microphones from the plurality of microphones. Furthermore, the method may include capturing, from the first virtual microphone at least one audio feed in a field of view (FOV) of the corresponding at least one camera. Finally, the method may include generating the spatial audio based on the captured at least one audio feed.

According to an embodiment of the disclosure, the generating the spatial audio may include obtaining (e.g. capturing) a first audio feed associated with the FOV of the at least one camera, and/or one or more second audio feeds associated with FOV of remaining cameras of the remaining display portions. According to an embodiment of the disclosure, the generating the spatial audio may include generating the spatial audio to be shared in an outbound stream by combining the first audio feed and the one or more second audio feeds. According to an embodiment of the disclosure, the generating the spatial audio may include combining the first audio feed and the one or more second audio feeds for generating the spatial audio to be shared in an outbound stream.

According to an embodiment of the disclosure, the first audio feed may be obtained (e.g. captured) using the first virtual microphone. The one or more second audio feeds may be obtained (e.g. captured) using one or more second virtual microphones associated with the remaining cameras.

According to an embodiment of the disclosure, the method may include obtaining (e.g. capturing) a plurality of frames associated at least one video feed from at least one camera of corresponding display portions. The method may include processing the obtained (e.g. captured) plurality of frames by adjusting a size of the plurality of frames based on one or more view parameters associated with the outbound stream. The method may include merging the adjusted plurality of frames to be shared in the outbound stream, wherein the outbound stream includes the combined video feeds and the spatial audio. The method may include transmitting the outbound steam on a remote user's device. According to an embodiment of the disclosure, the method may include obtaining (e.g. capturing) a plurality of frames associated at least two video feeds from at least two cameras of corresponding display portions. The method may include sending the outbound steam on a remote user's device.

According to an embodiment of the disclosure, the processing of the obtained (e.g. captured) plurality of frames may be performed based on a predefined frame per second (FPS) rate.

According to an embodiment of the disclosure, the method may include generating an interface associated with a corresponding view. The corresponding view may include the at least one video feed associated with the remote user and the obtained (e.g. captured) plurality of frames associated with the FOV of the at least one camera of the corresponding display portions. The method may include rendering the interface on the corresponding display portion. According to an embodiment of the disclosure, the method may include generating a corresponding interface associated with a corresponding view. The corresponding view may include the at least one video feed associated with the remote user and the obtained (e.g. captured) plurality of frames associated with the FOV of the at least one camera of the corresponding display portions. The method may include rendering the interface on the corresponding display portion.

According to an embodiment of the disclosure, the one or more view parameters may be a set of settings that define how the outbound stream should be displayed on the remote user's device.

According to an embodiment of the present disclosure, disclosed is an electronic device for generating spatial audio for a multi-user video conference call using a multi-fold user device having a plurality of display portions and a plurality of microphones. The electronic device may include a memory and at least one processor coupled to the memory. The at least one processor may be configured to determine an angular position of at least one camera such that the at least one camera is disposed on each of the plurality of display portions. Further, the at least one processor may be configured to determine an orientation of a corresponding user with respect to the at least one camera based on the determined angular position. Based on the determined orientation of the corresponding user and the determined angular position of the at least one camera, the at least one processor may be configured to create a first virtual microphone by selecting at least two microphones from the plurality of microphones. Further, the at least one processor may be configured to capture, from the first virtual microphone, at least one audio feed in a field of view (FOV) of the corresponding at least one camera. The at least one processor may be configured to generate the spatial audio based on the captured at least one audio feed.

According to an embodiment of the disclosure, to generate the spatial audio, the at least one processor may be configured to execute the one or more instructions to cause the electronic device to obtain (e.g. capture) a first audio feed associated with the FOV of the at least one camera, and/or one or more second audio feeds associated with FOV of remaining cameras of the remaining display portions. The at least one processor may be configured to execute the one or more instructions to cause the electronic device to combine the first audio feed and the one or more second audio feeds to generate the spatial audio to be shared in an outbound stream. The at least one processor may be configured to execute the one or more instructions to cause the electronic device to generate the spatial audio to be shared in an outbound stream by combining the first audio feed and the one or more second audio feeds.

According to an embodiment of the disclosure, the first audio feed may be obtained (e.g. captured) using the first virtual microphone. The one or more second audio feeds may be obtained (e.g. captured) by using one or more second virtual microphones associated with the remaining cameras.

According to an embodiment of the disclosure, the at least one processor may be configured to execute the one or more instructions to cause the electronic device to obtain (e.g. capture) a plurality of frames associated at least one video feed from at one camera of corresponding display portions. The at least one processor may be configured to execute the one or more instructions to cause the electronic device to obtain (e.g. capture) a plurality of frames associated at least two video feeds from at least two cameras of corresponding display portions. The at least one processor may be configured to execute the one or more instructions to cause the electronic device to process the obtained (e.g. captured) plurality of frames by adjusting a size of the plurality of frames based on one or more view parameters associated with the outbound stream. The at least one processor may be configured to execute the one or more instructions to cause the electronic device to merge the adjusted plurality of frames to be shared in the outbound stream, wherein the outbound stream includes the combined video feeds and the spatial audio. The at least one processor may be configured to execute the one or more instructions to cause the electronic device to transmit the outbound stream to a remote user's device. The at least one processor may be configured to execute the one or more instructions to cause the electronic device to send the outbound steam to be displayed on a remote user's device.

According to an embodiment of the disclosure, the processing the obtained (e.g. captured) plurality of frames may be performed based on a predefined frame per second (FPS) rate.

According to an embodiment of the disclosure, the at least one processor may be configured to execute the one or more instructions to cause the electronic device to generate an interface associated with a corresponding view. The at least one processor may be configured to execute the one or more instructions to cause the electronic device to generate a corresponding interface associated with a corresponding view. The corresponding view may include the at least one video feed associated with the remote user and the obtained (e.g. captured) plurality of frames associated with the FOV of the at least one camera of the corresponding display portions. The at least one processor may be configured to execute the one or more instructions to cause the electronic device to render the interface on the corresponding display portion. The at least one processor may be configured to execute the one or more instructions to cause the electronic device to render the corresponding interface on the corresponding display portion.

According to an embodiment of the disclosure, the one or more view parameters may be a set of settings that define how the outbound stream should be displayed on the remote user's device.

The method described in the embodiments herein enables adding another user into a video call using an additional camera disposed on the corresponding display portion of the multi-fold device 101. Further, the described method and system provide a consistent and synchronized video feed to remote users on mobile devices during the video conference call. Moreover, the described method and system ensures that the frames from each camera are seamlessly combined to meet the requirements of the outbound stream. Furthermore, the described method and system provide spatial context of each user independently using combination of mics present on the device.

An embodiment may provide a computer-readable recording medium having recorded thereon a program for causing a computer to execute the operating method of the electronic device 101 according to at least one of embodiments.

A program executable by the electronic device 101 described herein may be implemented as a hardware component, a software component, and/or a combination of hardware components and software components. The program is executable by any system capable of executing computer-readable instructions.

The software may include a computer program, code, instructions, or a combination of one or more thereof, and may configure the processor to operate as desired or may independently or collectively instruct the processor.

The software may be implemented as a computer program that includes instructions stored in computer-readable storage media. The computer-readable storage media may include, for example, magnetic storage media (e.g., ROM, RAM, floppy disks, or hard disks) and optical storage media (e.g., a compact disc ROM (CD-ROM) or a digital versatile disc (DVD)). The computer-readable recording medium may be distributed in computer systems connected via a network and may store and execute computer-readable code in a distributed manner. The recording medium may be computer-readable, may be stored in a memory, and may be executed by a processor.

The computer-readable storage medium may be provided in the form of a non-transitory storage medium. Here, the term ‘non-transitory storage medium’ refers to a tangible device and does not include a signal (e.g., an electromagnetic wave), and the term ‘non-transitory storage medium’ does not distinguish between a case where data is stored in a storage medium semi-permanently and a case where data is stored temporarily. For example, the ‘non-transitory storage medium’ may include a buffer in which data is temporarily stored.

In addition, a program according to embodiments disclosed herein may be provided in a computer program product. The computer program product may be traded as commodities between sellers and buyers.

The computer program product may include a software program and a computer-readable recording medium storing the software program. For example, the computer program product may include a product (e.g., a downloadable application) in the form of a software program electronically distributed through a manufacturer of the electronic device 101 or an electronic market (e.g., Samsung Galaxy Store). For electronic distribution, at least part of the software program may be stored in a storage medium or temporarily generated. In this case, the storage medium may be a storage medium of a server of the manufacturer of the electronic device 101, a server of the electronic market, or a relay server that temporarily stores the software program.

While specific language has been used to describe the present subject matter, any limitations arising on account thereto, are not intended. As would be apparent to a person in the art, various working modifications may be made to the method in order to implement the inventive concept as taught herein. The drawings and the foregoing description give examples of embodiments. Those skilled in the art will appreciate that one or more of the described elements may well be combined into a single functional element. Alternatively, certain elements may be split into multiple functional elements. Elements from one embodiment may be added to another embodiment.

What is claimed is:

1. A method, performed by an electronic device, of generating spatial audio for a multi-user video call, the method comprising:
determining an angular position of at least one camera, wherein the at least one camera is disposed on each of a plurality of display portions;
determining an orientation of a user with respect to the at least one camera based on the determined angular position;
obtaining a first virtual microphone by selecting at least two microphones from among a plurality of microphones based on the determined orientation of the user and the determined angular position of the at least one camera;
obtaining, by using the first virtual microphone, at least one audio feed in a field of view (FOV) of the at least one camera; and
generating the spatial audio based on the obtained at least one audio feed.

2. The method as claimed in claim 1, wherein the generating the spatial audio comprises:
obtaining a first audio feed associated with the FOV of the at least one camera, and one or more second audio feeds associated with FOV of remaining cameras corresponding to remaining display portions of the plurality of display portions; and
generating the spatial audio to be shared in an outbound stream by combining the first audio feed and the one or more second audio feeds.

3. The method as claimed in claim 2, wherein the first audio feed is obtained by using the first virtual microphone, and the one or more second audio feeds are obtained by using one or more second virtual microphones associated with the remaining cameras.

4. The method as claimed in claim 2, further comprising:
obtaining a plurality of frames associated with at least one video feed from the at least one camera of corresponding display portions of the plurality of display portions;
processing the obtained plurality of frames by adjusting a size of the plurality of frames based on one or more view parameters associated with the outbound stream;
merging the adjusted plurality of frames to be shared in the outbound stream, wherein the outbound stream comprises the combined the at least one video feed and the spatial audio; and
transmitting the outbound steam to a remote user's device.

5. The method as claimed in claim 4, wherein the processing of the obtained plurality of frames is performed based on a predefined frame per second (FPS) rate.

6. The method as claimed in claim 4, further comprising:
generating an interface associated with a corresponding view, wherein the corresponding view comprises the at least one video feed associated with the remote user and the obtained plurality of frames associated with the FOV of the at least one camera of the corresponding display portions;
and rendering the interface on the corresponding display portion.

7. The method as claimed in claim 4, wherein the one or more view parameters is a set of settings that define how the outbound stream is displayed on the remote user's device.

8. An electronic device for generating spatial audio for a multi-user video call, the electronic device comprises:
a plurality of display portions;
at least one camera;
a plurality of microphones;
a memory storing one or more instructions;
at least one processor coupled to the memory configured to execute the one or more instructions to cause the electronic device to:
determine an angular position of the at least one camera, wherein the at least one camera is disposed on each of the plurality of display portions;
determine an orientation of a user with respect to the at least one camera based on the determined angular position;
obtain a first virtual microphone by selecting at least two microphones from among the plurality of microphones based on the determined orientation of the user and the determined angular position of the at least one camera;
obtain, by using the first virtual microphone, at least one audio feed in a field of view (FOV) of the at least one camera; and
generate the spatial audio based on the obtained at least one audio feed.

9. The electronic device as claimed in claim 8, wherein to generate the spatial audio, the at least one processor is further configured to execute the one or more instructions to cause the electronic device to:
obtain a first audio feed associated with the FOV of the at least one camera, and one or more second audio feeds associated with FOV of remaining cameras of remaining display portions of the plurality of display portions; and
generate the spatial audio to be shared in an outbound stream by combining the first audio feed and the one or more second audio feeds.

10. The electronic device as claimed in claim 9, wherein the first audio feed is obtained by using the first virtual microphone, and the one or more second audio feeds are obtained by using one or more second virtual microphones associated with the remaining cameras.

11. The electronic device as claimed in claim 9, wherein the at least one processor is further configured to execute the one or more instructions to cause the electronic device to:
obtain a plurality of frames associated at least one video feed from at least one camera of corresponding display portions of the plurality of display portions;
process the obtained plurality of frames by adjusting a size of the plurality of frames based on one or more view parameters associated with the outbound stream;
merge the adjusted plurality of frames to be shared in the outbound stream, wherein the outbound stream comprises the combined the at last one video feed and the spatial audio; and
transmit the outbound steam to a remote user's device.

12. The electronic device as claimed in claim 11, wherein processing the obtained plurality of frames is performed based on a predefined frame per second (FPS) rate.

13. The electronic device as claimed in claim 11, wherein the at least one processor is further configured to execute the one or more instructions to:
generate an interface associated with a corresponding view, wherein the corresponding view comprises the at least one video feed associated with the remote user and the obtained plurality of frames associated with the FOV of the at least one camera of the corresponding display portions; and
render the interface on the corresponding display portion.

14. The electronic device as claimed in claim 11, wherein the one or more view parameters is a set of settings that define how the outbound stream is displayed on the remote user's device.

15. A non-transitory computer-readable storage medium storing instructions, wherein the instructions, when executed by at least one processor, cause the electronic device to perform the method of claim 1.
